(19) United States
(12) Patent Application Publication
(10) Pub. No.: US 2015/0047153 A1
(43) Pub. Date: Feb. 19, 2015

(54) HANDLE STRUCTURE

(71) Applicant: Yu-Lin CHIANG, Taipei City (TW)

(72) Inventor: Yu-Lin CHIANG, Taipei City (TW)

(21) Appl. No.: 13/966,206

(22) Filed: Aug. 13, 2013

(51) Int. Cl. A47J 45/06

(52) U.S. Cl. CPC A47J 45/06
USPC 16/430

(57) ABSTRACT

A handle structure has a head portion, a neck portion and a main body. One end of the head portion is connected to an attached object, and the neck portion extends from the head portion towards to the main body and having a first recess at a middle position. A first protrusion portion is disposed on a middle position of the main body, and two second protrusion portions are disposed correspondingly at two sides of the first protrusion portion. Each protrusion portion has an oval shape. The handle structure is suitable for the left-handed or right-handed user and different grabbing manners and provides more stability.

### BACKGROUND OF THE INVENTION

1. Field of the Invention

The present invention relates to a handle structure, and more particularly to a handle structure for cookware or other similar attached objects.

2. Description of the Related Art

Currently, various cookwares are usually designed with handles; however most of the handles do not match ergonomics design.

As shown in FIG. 15, a prior art cookware has a pot body 10, a handle 20. The handle 20 is attached on to the pot body 10 and provides a curved bottom surface. However, the handle 20 is not specifically designed for a left-handed or right-handed user, and not suitable for different grabbing manners.

Therefore, it is desirable to provide a handle structure to mitigate and/or obviate the aforementioned problems.

### SUMMARY OF THE INVENTION

An objective of the present invention is to provide a handle structure, which is designed for cookwares such attached objects and suitable for the left-handed or right-handed user and different grabbing manners.

In order to achieve the above mentioned objective, the handle structure has a head portion, a neck portion and a main body. One end of the head portion is connected to an attached object, and the neck portion extends from the head portion towards to the main body and having a first recess at a middle position. A first protrusion portion is disposed on a middle position of the main body, and two second protrusion portions are disposed correspondingly at two sides of the first protrusion portion. Each protrusion portion has an oval shape.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is a perspective schematic drawing showing a handle being attached onto a cookware according to the present invention.

FIG. 3 is a top view showing a user holding a far end of the handle according to the present invention.

FIG. 4 is a side view showing the user holding the far end of the handle according to the present invention.

FIG. 5 is another side view showing the user holding the far end of the handle according to the present invention.

FIG. 6 is a top view showing the user holding the far end of the handle in a different manner according to the present invention.

FIG. 7 is a side view showing the user holding the far end of the handle in a different manner according to the present invention.

FIG. 8 is another side view showing the user holding the far end of the handle in a different manner according to the present invention.

FIG. 9 is a top view showing the user holding a close end of the handle according to the present invention.

FIG. 10 is a side view showing the user holding the close end of the handle according to the present invention.

FIG. 11 is another side view showing the user holding the close end of the handle according to the present invention.

FIG. 12 is a top view showing the user holding the close end of the handle in a different manner according to the present invention.

FIG. 13 is a side view showing the user holding the close end of the handle in a different manner according to the present invention.

FIG. 14 is another side view showing the user holding the close end of the handle in a different manner according to the present invention.

FIG. 15 is a perspective drawing of a prior art cookware.

### DETAILED DESCRIPTION OF THE PREFERRED EMBODIMENT

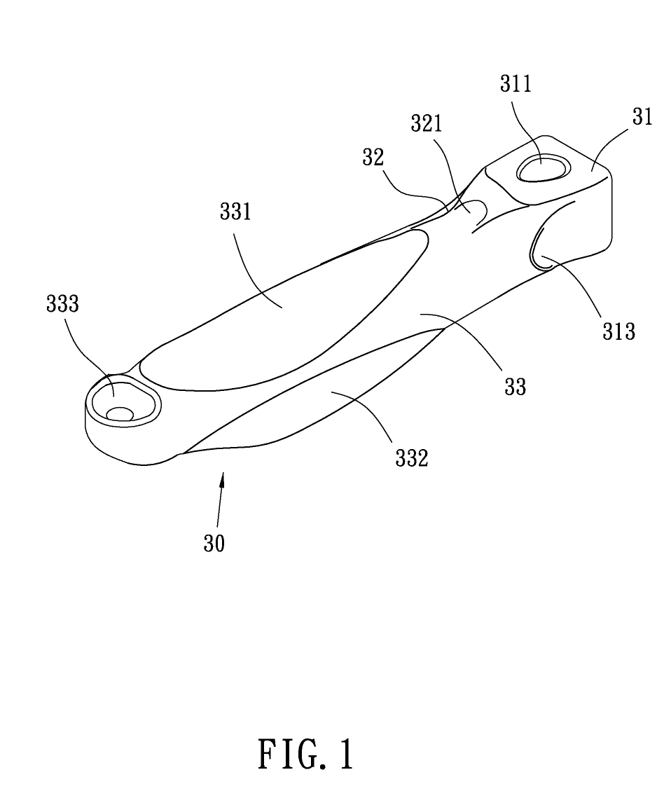

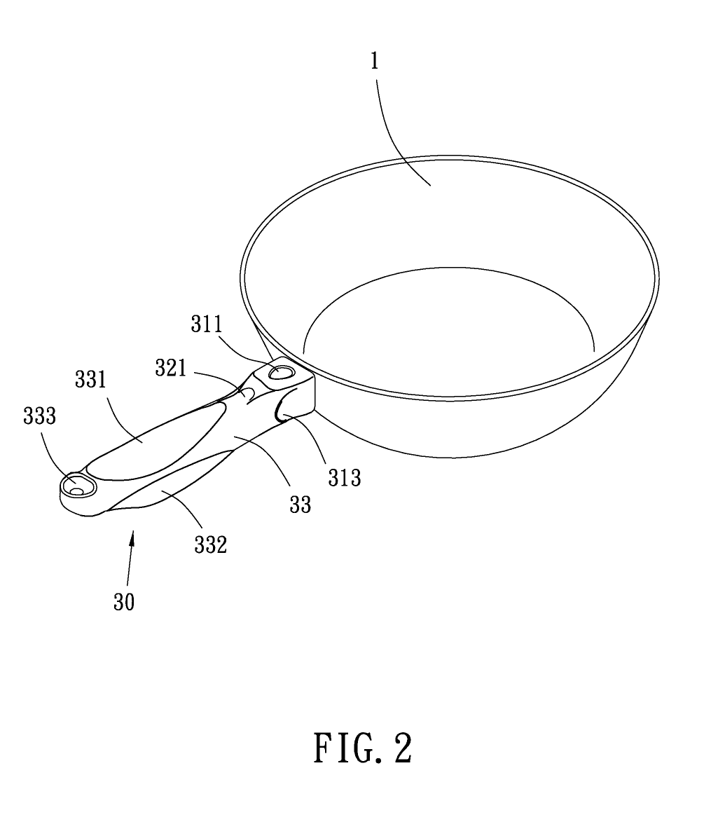

Please refer to FIG. 1-FIG. 14. A handle 30 is attached onto a cookware or other similar attached objects 1.

The handle 30 comprises a head portion 31, a neck portion 32 and a main body 33. One free end of the head portion 31 is used for being secured onto the attached object 1. A second recess 311 is formed on a top surface of the head portion, a third recess 312 is formed on a left side of the head portion, and a fourth recess 313 is formed on a right side of the head portion. The neck portion 32 extends from the head portion 31 towards to the main body 33 and has a first recess 321 at a middle position. The first recess 321 is used for the user to rest his or her thumb. Furthermore, several protrusion portions 331, 332 are formed on the main body 33, and the protrusion portions 331, 332 both have an oval shape. One first protrusion portion 331 is disposed on a top side of the main body 33, and two second protrusion portions 332 are disposed on two corresponding sides of the main body 33. Therefore, the user can make his or her thumb and index finger to touch a front edge of the two protrusion portions 332 or his or her thumb to touch a front edge of the first protrusion portion 331. In addition, a rear free end of the main body 33 is provided with a hanging loop 333.

Accordingly, the head portion 31 is provided with the second recess 311, the third recess 312 and the fourth recess 313, the neck portion 32 is provided with the first recess 321, and the main body 33 is provided with three protrusion portions 331, 332. Therefore, the handle 30 matches ergonomics design and is suitable for both the left-handed user and right-handed user or different grabbing manners.

The handle 30 is suitable for following 4 different grabbing manners: the first far-end grabbing manner, the second far-end grabbing manner, the first close-end grabbing manner, and the second close-end grabbing manner.

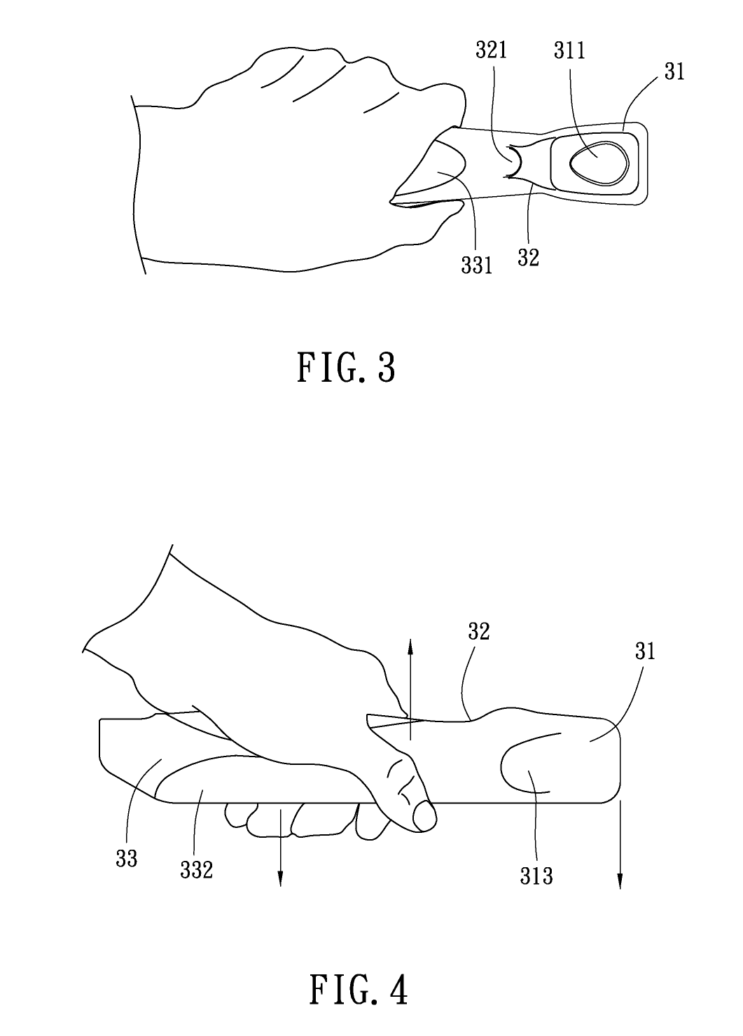

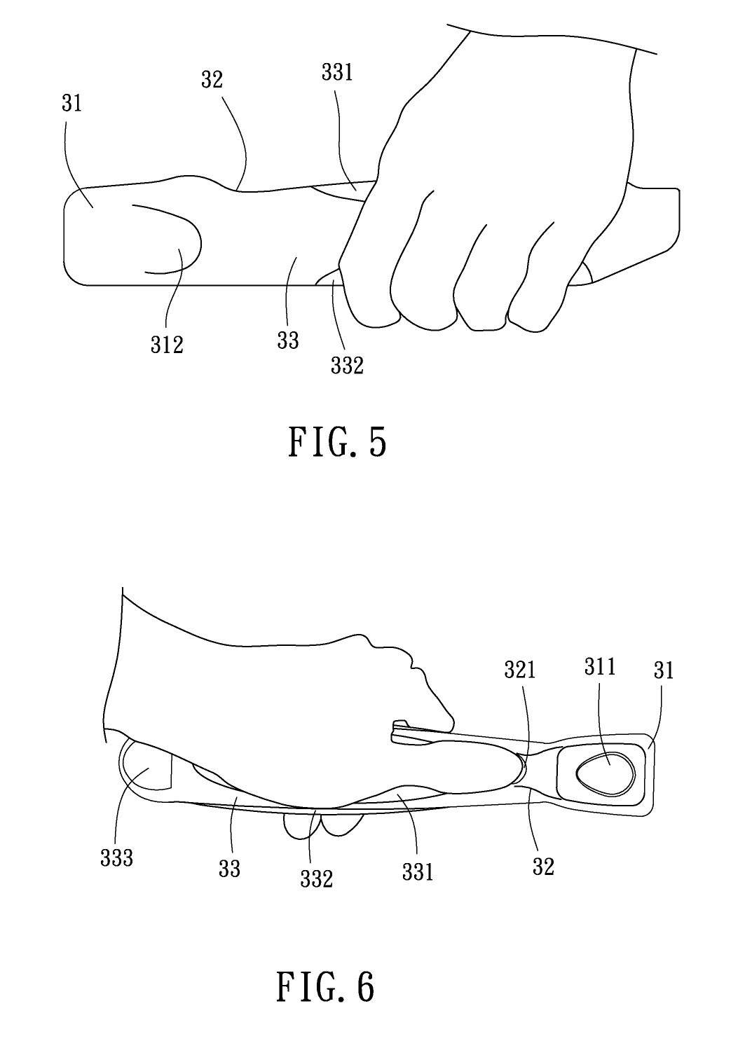

1. The first far-end grabbing manner: when the user wants to stay away from the high temperature source or create bigger motions, he or she can use the first far end grabbing manner, as shown in FIG. 3. The thumb and index finger of the user are placed on the opposite sides of the handle 30, and the plum and the other fingers grab from one side of the handle 30, as shown in FIG. 4. The second protrusion portions 332 help the thumb and index finger to make a better contact with the handle 30, as shown in FIG. 4 and FIG. 5. The protrusion portions 331, 332 on the main body 33 help the plum and the other fingers to make a better contact with the handle 30. Furthermore, the protrusion portions 331, 332 increase the grip strength generated from the plum, which can reduce the load from the thumb and index finger and also provide more stability.

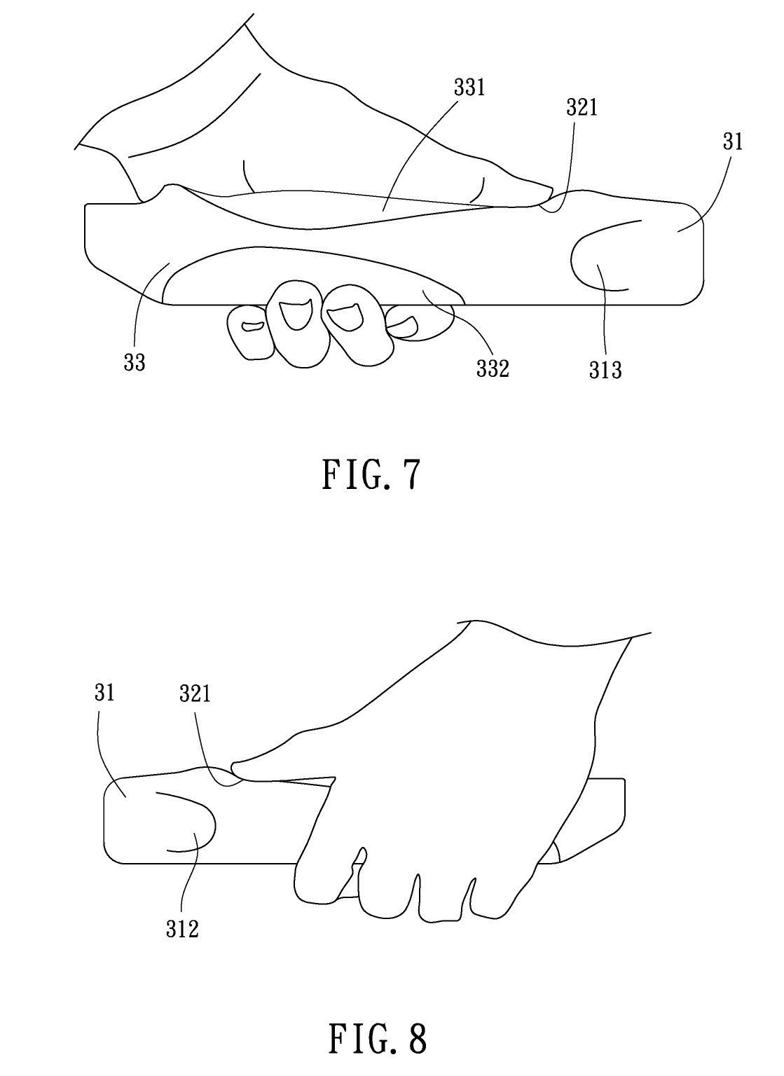

2. The second far-end grabbing manner: when the user wants to stay away from the high temperature source or create more left and right swing motions with his or her forearm, he or she can use the second far-end grabbing manner, as shown in FIG. 6. The thumb of the user placed on the top surface of the handle 30, and the other fingers are placed on the second protrusion portion 332, as shown in FIG. 7 and FIG. 8. The first protrusion portion and the first recess 321 of the neck portion 32 help the thumb of the user to make a better contact with the handle 30, as shown in FIG. 7.

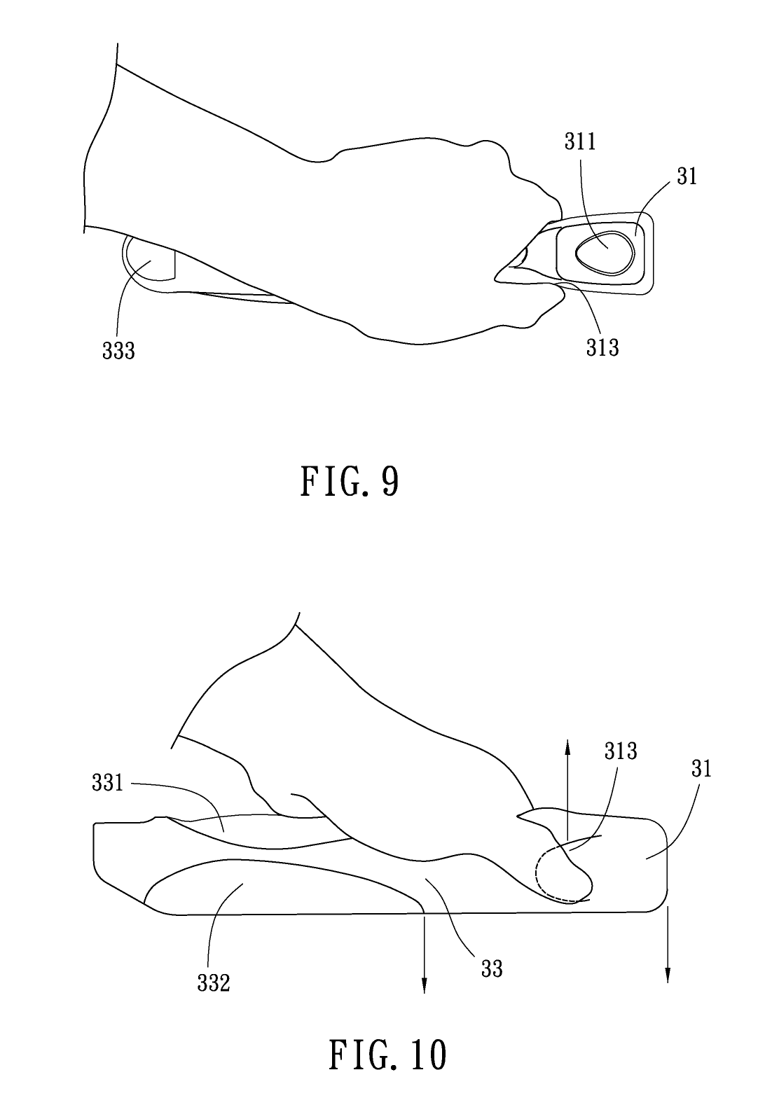

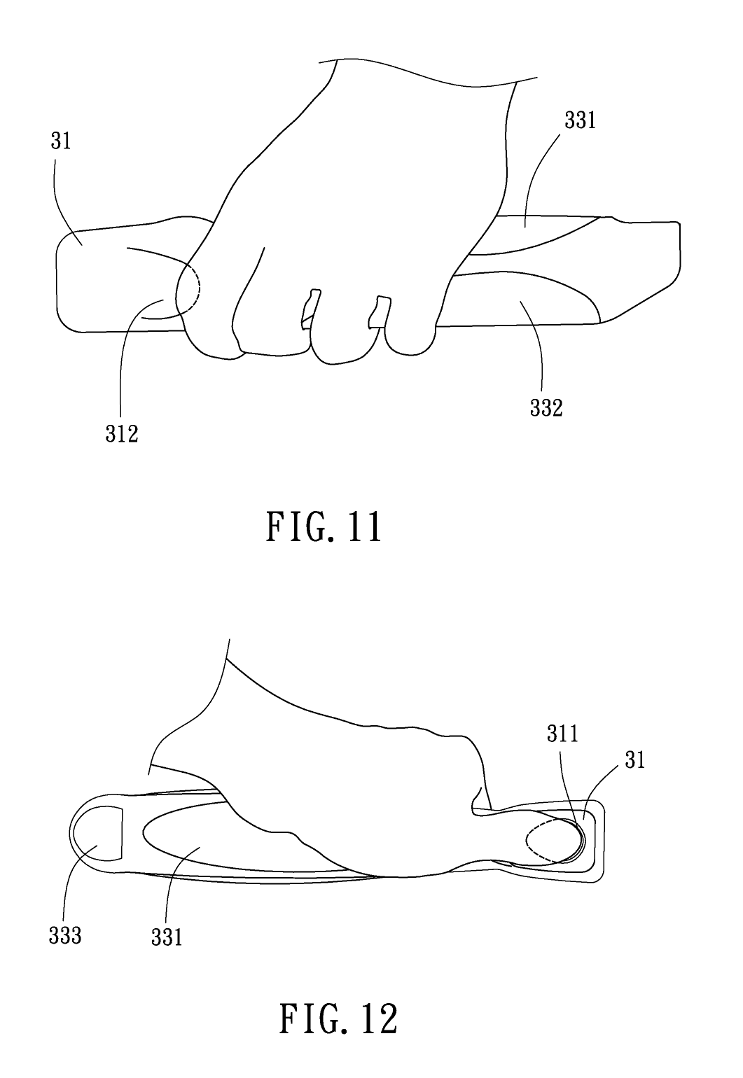

3.The first close-end grabbing manner: when the user wants to save strength, he or she can use first close-end grabbing manner, as shown in FIG. 9. The thumb and index finger of the user are placed on the opposite sides of the handle 30, and the plum and the other fingers grab from one side of the handle 30, as shown in FIG. 10. The third and fourth recesses 312, 313 on the opposite sides of the neck portion 32 help the thumb and index finger to make a better contact with the handle 30, as shown in FIG. 10 and FIG. 11. The protrusion portions 331, 332 on the main body 33 help the plum and the other fingers to make a better contact with the handle 30. Furthermore, the protrusion portions 331, 332 increase the grip strength generated from the plum, which can reduce the load from the thumb and index finger and also provide more stability.

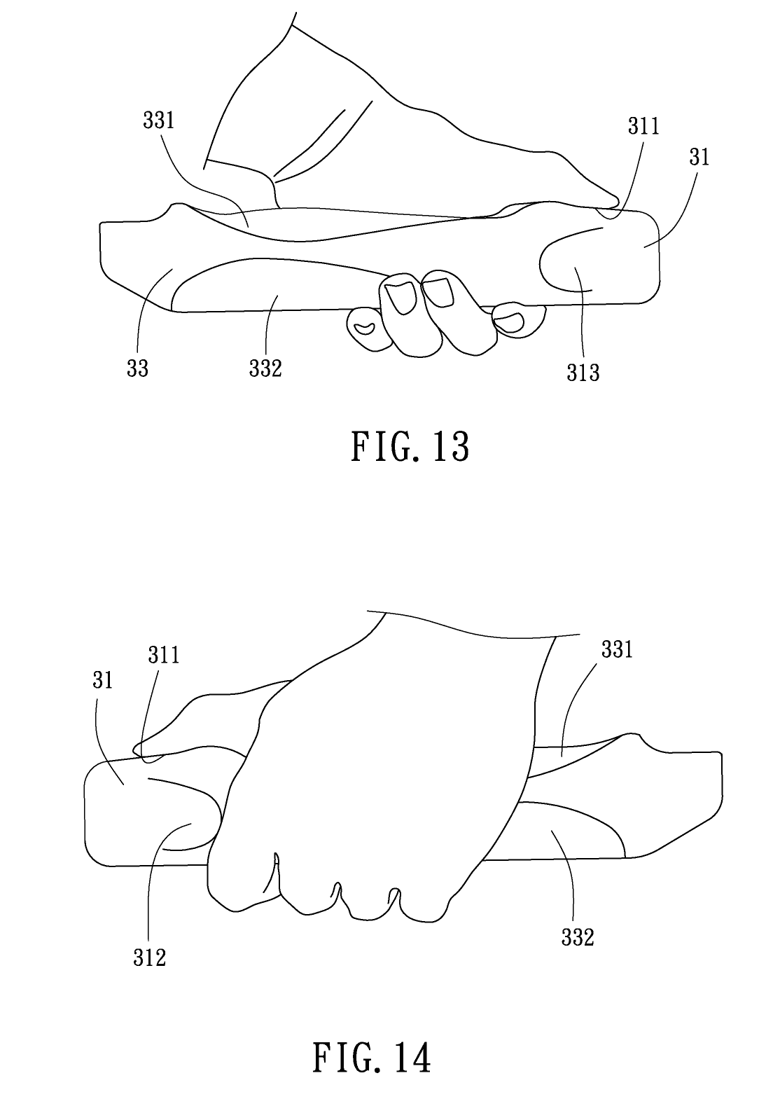

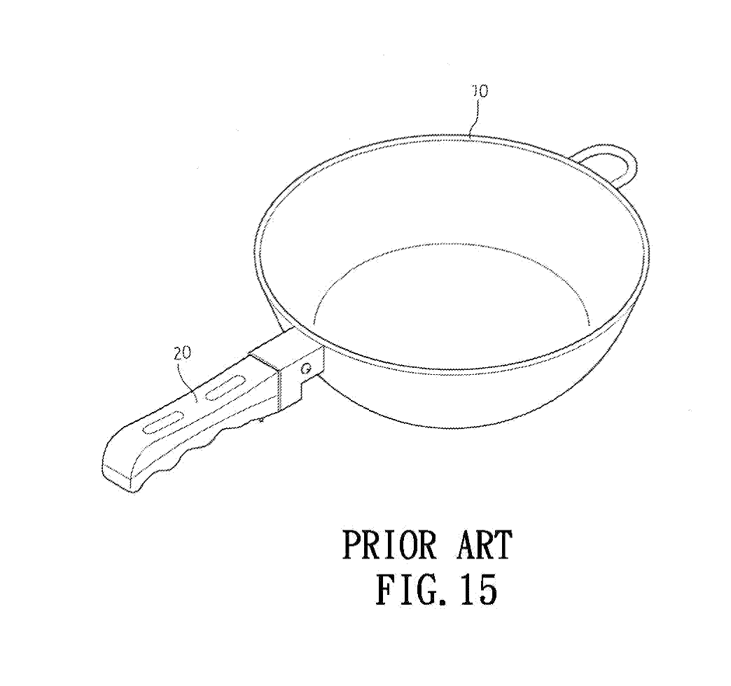

4. The second close-end grabbing manner: when the user wants to save strength and create more left and right swing motions with his or her forearm, he or she can use the second close-end grabbing manner, as shown in FIG. 12. The thumb of the user placed on the top surface of the handle 30, and the other fingers are placed on the second protrusion portion 332, as shown in FIG. 13 and FIG. 14. The first protrusion portion and the second recess 311 of the head portion 31 helps the thumb of the user to make a better contact with the handle 30, as shown in FIG. 13.

Although the present invention has been explained in relation to its preferred embodiment, it is to be understood that many other possible modifications and variations can be made without departing from the spirit and scope of the invention as hereinafter claimed.

What is claimed is:

1. A handle structure comprising a head portion, a neck portion and a main body; a free end of the head portion connected to an attached object, the neck portion extending from the head portion towards to the main body and having a first recess at a middle position; a first protrusion portion disposed on a middle position of the main body, two second protrusion portions disposed correspondingly at two sides of the first protrusion portion; each protrusion portion having an oval shape.

2. The handle structure as claimed in claim 1, wherein a second recess is formed at an upper edge of the head portion of the handle structure.

3. The handle structure as claimed in claim 1, wherein a third recess is formed at a left side of the head portion.

4. The handle structure as claimed in claim 1, wherein a fourth recess is formed at a right side of the head portion.

5. The handle structure as claimed in claim 1, wherein a loop is formed at a free end of the main body.
